(19) United States
(12) Patent Application Publication
(10) Pub. No.: US 2004/0030614 A1
(43) Pub. Date: Feb. 12, 2004

(54) Computer-implemented method and system for managing workload of procurement individuals

(76) Inventors: Jay C. Shields, Canton, MI (US); Suzanne Mazurek, Novi, MI (US)

Correspondence Address: BROOKS KUSHMAN P.C./FGTL, 1000 TOWN CENTER, 22ND FLOOR, SOUTHFIELD, MI, 48075-1238, US

(21) Appl. No.: 10/464,363

(22) Filed: Jun. 18, 2003

Related U.S. Application Data
(60) Provisional application No. 60/390,005, filed on Jun. 19, 2002.

(51) Int. Cl. G06F 17/60

(52) U.S. Cl. 705/26

(57) ABSTRACT

A computer-implemented method for managing workload of procurement buyers is disclosed. The method includes automatically assigning at least one of a plurality of requisition documents to an assigned buyer based on buyer information and the organization and the requisition number of the at least one requisition documents to obtain an at least one assigned requisition document and formatting information contained in the at least one assigned requisition document to obtain formatted requisition information for display to the assigned buyer. The formatted requisition information can be relied upon by the procurement buyer to manage workload.

### CROSS-REFERENCE TO RELATED APPLICATION

This application claims the benefit of U.S. Provisional application Serial No. 60/390,005, filed Jun. 19, 2002, and entitled “Method And System For Assigning Requisition Documents To Buyers”.

### BACKGROUND OF THE INVENTION

1. Field of the Invention

One aspect of the present invention relates generally to a computer-implemented method and system for managing workload of procurement individuals, including requisitioners and buyers.

2. Background Art

A distributed enterprise is an organization having multiple lead operating units spread across a geographic region, continent or globe. In today's business environment, thousands of businesses have lead operating units facilities located in more than one country or continent. For example, an automobile manufacturer may have multiple management facilities, engineering facilities, manufacturing facilities, assembly facilities, distribution facilities, sales facilities and service facilities located within most countries and every continent on the planet. Each of these facilities must, in turn, deal with a second-tier of often equally-distributed supplier communities.

Distributed enterprises present a unique challenge to conventional electronic procurement management software. Most procurement systems are tailored to effectively meet the needs of smaller to mid-sized businesses having a few, if any, distributed business operating units or supplier base. However, these conventional systems lack functionality to effectively support certain business needs of large to very large companies with multiple lead operating units that are distributed across a wide geographical range.

For years, electronic data interchange (EDI) and virtual private network (VPN) technologies have enabled businesses and their suppliers to exchange invoices, purchase orders, and other documents to conduct their day-to-day business online. Typically, these systems were proprietary in nature, required a dedicated technical infrastructure, and required a costly subscription or pay-per-use access arrangement.

The advent of the Internet has revolutionized electronic procurement systems by increasing the speed and decreasing the costs associated with the first-generation systems. Without such access barriers, buyers are presented with a broader horizon of potential suppliers. Today, a buyer organization can access the Internet to obtain pricing information, product and service information, submit a purchase request, route the request for approval, view the fulfillment status of the request, receive a receipt and delivery notification, and transmit payment.

According to one IDC survey conducted in September 2000, the amount of savings generated with the use of an Internet-enabled procurement system will, on average, range from 5.0% to 8.5% of a company's purchasing budget. Depending on the size of the company, this savings can translate to over a billion dollars annually.

In the manufacturing industry, resource demand can be generalized into two broad categories: direct and indirect. Direct procurement includes the purchasing of resources that make up the product ultimately being manufactured. Indirect procurement includes the purchasing of “support” resources that are necessary to bring about the manufacture of the product. In an automobile manufacturing example, a direct resource might be the paint or windshield for a particular automobile. An indirect resource might include a day-to-day commodity such as wrenches or safety glasses that, although not technically a part of the automobile, are indirectly or directly necessary to manufacture the automobile. The indirect procurement process is generally comprised of (1) a requisitioner issuing a requisition, (2) a buyer receiving the requisition, and (3) the buyer using the requisition for quoting sourcing, and purchase order issuance. The direct procurement process is generally comprised of an electronic demand for a quantity of an item being fed to purchasing to source and order the item in the quantity identified.

Today, companies such as General Electric and Compaq Computer have integrated electronic procurement systems to streamline the online sourcing and purchasing of direct and indirect materials. For example, Compaq Computer employees can use their Web browser to view an online supplier catalog of over 37,000 items, and easily purchase the resources necessary to satisfy their day-to-day needs. Companies such as Compaq can expand this functionality to increase the variety of resources available, rationalize its supply base, and consolidate its supply chain in an effort to leverage purchase volumes into fewer suppliers and improve its relationship with a preferred supply base.

Issued U.S. patents relating to electronic procurement applications and systems include U.S. Pat. No. 5,970,475 to Barnes et al. and U.S. Pat. No. 6,363,365 to Kou. Published U.S. patent applications relating to electronic procurement applications and systems include U.S. patent application Ser. No. 2001/0042050 to Fletcher et al. Additional information relating to electronic procurement systems includes Albert Pang's IDC White Paper eProcurement Ensures Visionary Companies a Place in the New Economy, Jul. 2001.

One electronic procurement application is Oracle Procurement. A detailed description of the Oracle Procurement application can be found at www.oracle.com.

Other developers of procurement solutions include Ariba (www.ariba.com), i2 (www.i2.com), CommerceOne (www.commerceone.com), SAP (www.sap.com) and PeopleSoft (www.peoplesoft.com).

As comprehensive and beneficial as today's procurement systems may be, there still remains a wide horizon for improvement. For example, Oracle standard functionality receives and stores requisition documents from a requisitioner in a document warehouse. If the requisitioner does not specify a purchasing organization on the requisition document, a buyer is not alerted that the requisitioner has transmitted such documents. This situation occurs often since a requistioner may not know the buyer's name. Assuming that the buyer knows the location of the requisition documents in the document warehouse, the purchasing organization has to query and pull the requisition documents into the buying part of the Oracle system in order to initiate the buying function (i.e., quoting, sourcing, purchase order issuance).

What is needed is a method and system for alerting the purchasing organization of the presence of requisition documents and transmitting the requisition documents to a buyer's work list without intervention. Moreover, a method and system is needed for gathering requisition documents pertinent to the requisitioning function in a central location. Additionally, a method and system is needed for gathering requisition documents pertinent to the buying function in a central location.

### SUMMARY OF THE INVENTION

According to a first embodiment of the present invention, a computer-implemented method for managing workload of procurement buyers is disclosed. The method includes receiving a requisition database, the requisition database including a plurality of requisition documents, each of the plurality of requisition documents including an organization and a requisition number, the plurality of requisition documents being assigned to at least two different operating units, receiving buyer information of one or more buyers that are responsible for procuring products or services in at least two operating units based on at least one of the plurality of requisition documents, automatically assigning at least one of the plurality of requisition documents to an assigned buyer selected from the one or more buyers based on the buyer information and the organization and the requisition number of the at least one requisition documents to obtain an at least one assigned requisition document and formatting information contained in the at least one assigned requisition document to obtain formatted requisition information for display to the assigned buyer. The formatted requisition information can be relied upon by the procurement buyer to manage workload.

The one or more buyers are responsible for procuring products or services in at least two legal entities. The formatted requisition information can be displayed to the assigned buyer in an electronic form. The electronic form can include one or more tabs. In certain embodiments, the one or more tabs can include a requisitions tab. In other embodiments, the one or more tabs can include a requisitions tab, a pre-quoted requisition tab, and an amendment requests tab. In yet other embodiments, the one or more tabs can include at least five of the following tabs: a requisitions tab, a pre-quoted requisition tab, an amendment requests tab, and APN tab, an RFQs tab, a recap tab, a purchase order tab, a PO approvals tab, a messages tab and ASN tab. The method can further include assigning at least on of the one or more requisition documents from the assigned buyer to a buddy buyer.

According to a second embodiment of the present invention, a computer-implemented system for managing workload of procurement buyers. The system includes at least one server computer for communicating with at least one client computer. The at least one server computer can be configured to receive a requisition database, the requisition database including a plurality of requisition documents, each of the plurality of requisition documents including an organization and a requisition number, the plurality of requisition documents being assigned to at least two different operating units, receive buyer information of one or more buyers that are responsible for procuring products or service in at least two operating units based on at least one of the plurality of requisition documents, automatically assign at least one of the plurality of requisition documents to an assigned buyer selected from the one or more buyers based on the buyer information, and the organization and the requisition number of the at least one requisition documents to obtain an at least one assigned requisition document, format information contained in the at least one assigned requisition document to obtain formatted requisition information for display to the assigned buyer. The formatted requisition information can be relied upon by the procurement buyer to manage workload.

The one or more buyers are responsible for procuring products or services in at least two legal entities. The formatted requisition information is displayed to the assigned buyer in an electronic form. The electronic form can include one or more tabs. In certain embodiments, the one or more tabs can include a requisitions tab. In other embodiments, the one or more tabs can include a requisitions tab, a pre-quoted requisition tab, and an amendment requests tab. In yet other embodiments, the one or more tabs can include at least five of the following tabs: a requisitions tab, a pre-quoted requisition tab, an amendment requests tab, and APN tab, an RFQs tab, a recap tab, a purchase order tab, a PO approvals tab, a messages tab and ASN tab. The at least one server computer can be further configured to assign at least on of the one or more requisition documents from the assigned buyer to a buddy buyer.

According to a third embodiment of the present invention, a program for controlling a computer of a server for managing workload of procurement buyers is disclosed. The program includes instructions for receiving a requisition database, the requisition database including a plurality of requisition documents, each of the plurality of requisition documents including an organization and a requisition number, the plurality of requisition documents being assigned to at least two different operating units, instructions for receiving buyer information of one or more buyers that are responsible for procuring products or service in at least two operating units based on at least one of the plurality of requisition documents, instructions for automatically assigning at least one of the plurality of requisition documents to an assigned buyer selected from the one or more buyers based on the buyer information and the organization and the requisition number of the at least one requisition documents to obtain an at least one assigned requisition document and instructions for formatting information contained in the at least one assigned requisition document to obtain formatted requisition information for display to the assigned buyer. The formatted requisition information can be relied upon by the procurement buyer to manage workload.

According to a fourth embodiment of the present invention, a computer-implemented method for managing workload of procurement requisitioners is disclosed. The method includes receiving a requisition database, the requisition database including a plurality of requisition documents, each of the plurality of requisition documents including an organization, a requisition number and a requisitioner and formatting the information contained in at least one requisition document to obtain formatted requisition information for display to the requisitioner associated with the requisition document. The requisitioner associated with the requisition document is responsible for procurement in at least two operating units. The formatted requisition information can be relied upon for the procurement of products or services.

The formatted requisition information can be displayed to the requisitioner in an electronic form. The electronic form can include one or more tabs. The one or more tabs can include a returns tab. The one or more tabs can include a returns tab, an approver rejected tab, and an ASNs tab. In certain embodiments, the one or more tabs include at least five of the following tabs: a returns tab, an approver rejected tab, an ASNs tab, an in process tab, an incomplete tab, an approvals tab, an open purchase orders tab, an approved reqs tab and a message tab.

According to a fifth embodiment of the present invention, a computer-implemented system for managing workload of procurement requisitioners. The system includes at least one server computer for communicating with at least one client computer. The at least one server computer can be configured to receive a requisition database, the requisition database including a plurality of requisition documents, each of the plurality of requisition documents including an organization, a requisition number and a requisitioner and format the information contained in at least one requisition document to obtain formatted requisition information for display to the requisitioner associated with the requisition document. The requisitioner associated with the requisition document is responsible for procurement in at least two operating units. The formatted requisition information can be relied upon for the procurement of products or services.

The above embodiments and other embodiments, features, and advantages of the present invention are readily apparent from the following detailed description of the best mode for carrying out the invention when taken in connection with the accompanying drawings.

### BRIEF DESCRIPTION OF THE DRAWINGS

The features of the present invention which are believed to be novel are set forth with particularity in the appended claims. The present invention, together with further objects and advantages thereof, may be best understood with reference to the following description, taken in connection with the accompanying drawings:

FIG. 1 is a schematic diagram illustrating a system embodiment for implementing certain methods of the present invention;

FIG. 2 is an example of a form for displaying buyer workbench information in accordance with an embodiment of the present invention;

FIG. 3 is an example of a form for displaying buddy workgroup information in accordance with an embodiment of the present invention; and

FIG. 4 is an example of a form for displaying requisitioner workbench information in accordance with an embodiment of the present invention.

### DETAILED DESCRIPTION OF EMBODIMENTS OF THE PRESTENT INVENTION

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as representative basis for teaching one skilled in the art to variously employ in the present invention.

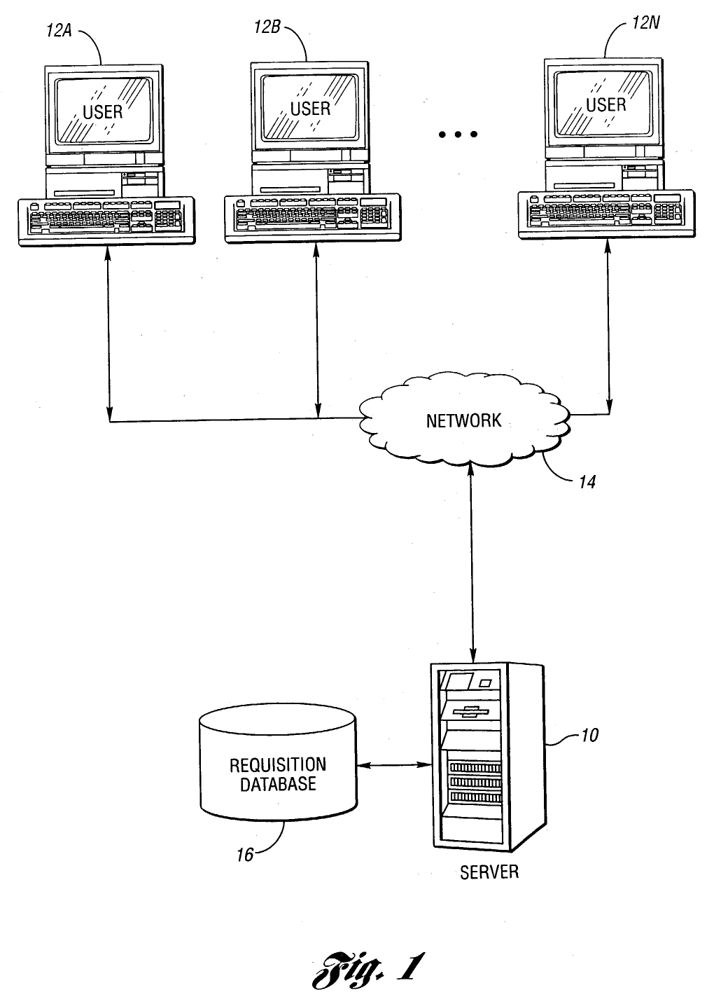

FIG. 1 is a schematic diagram illustrating a system embodiment for implementing certain methods of the present invention. It should be understood that the diagram can be modified, rearranged, deleted, added upon, or amplified based on a particular embodiment of the present invention.

FIG. 1 illustrates an at least one server computer 10 operably serving a plurality of client computers 12A-N, which can communicate with server computer 10 utilizing a TCP-IP communication protocol via network/LAN 14. Server computer 10 can be configured to operably store data to, and retrieve information from, at least one requisition database 16. In certain embodiments, the requisition database contains a document warehouse, which includes a plurality of requisition documents.

Buyers Workbench Tool Functionality

The buyers workbench tool allows buyers to access their notifications and notification details, launch purchasing documents and close notifications from a single screen and menu path.

The buyers workbench tool includes the ability to display buyer's notifications and documents across operating units.

The buyers workbench tool includes the ability to launch notification details.

The buyers workbench tool includes the ability to launch Purchasing Document using the notifications.

The buyers workbench tool includes the ability to automatically switch responsibilities for launching purchasing documents and detailed notifications across responsibilities.

The buyers workbench tool includes the ability to categorize buyer's notifications and documents into meaningful folder names.

The buyers workbench tool includes the ability to categorize FYI notifications in a separate Folder.

The buyers workbench tool includes the ability to categorize all other miscellaneous notifications in a miscellaneous folder.

The buyers workbench tool includes the ability to close notifications using the workbench.

The buyers workbench can be the central place for a buyer to perform his daily operations. A buyer can have access to responsibilities covering multiple operating units and notifications and documents can be triggered due to actions in any of the operating units. The buyers workbench can be accessible in all responsibilities and can consolidate notifications and documents, no matter which operating unit they are triggered from. A buyer should not have to switch multiple responsibilities to access his/her notifications.

A buyer can launch the notification detail for each notification using a button on the buyers workbench.

The buyer can launch and automatically query the appropriate Purchasing Document, (for example, Purchase Order, Requisition needing auto-creation by Buyer, and RFQ) using the Buyers Workbench. This involves launching the correct form and querying the appropriate record in the launched form automatically based on the data in notification header.

The buyers workbench can automatically switch the responsibility of a buyer, based on the Operating Unit (org_id) from which the notification was generated. The responsibility switch can be transparent to the buyer.

The notifications and documents can be grouped into following folders/categories based on their applicability: requisitions, RFQs, quotations, purchase orders, MISC, and FYI.

Notifications that are informational and do not require action by the buyer can be grouped under the FYI category.

Notification on miscellaneous issues (i.e., Returned Purchase Order, ASN submissions) can be grouped under the MISC category.

A buyer can close notifications and requests using the workbench. The closed notifications are optionally not visible from the buyers workbench.

The buyers workbench tool includes the ability for the buyer to monitor and manage the life of a requisition (request) from the initial request to order procurement. One or more points in the life of a requisition can be listed in a work list table with a number of items at that point for a buyer. Non-limiting examples of points can include, but are not limited to, requisitions, pre-quoted reqs, amendment requests, APN, RFQs, ReCap, PO, PO Approval and ASN. The work list table can be displayed to the buyer through a graphical user interface. The buyer can review a table to monitor and manage workload.

The buyer workbench tool functionality can be implemented using an Oracle procurement application. It should be understood that other procurement applications can be enhanced with the buyer workbench tool functionality.

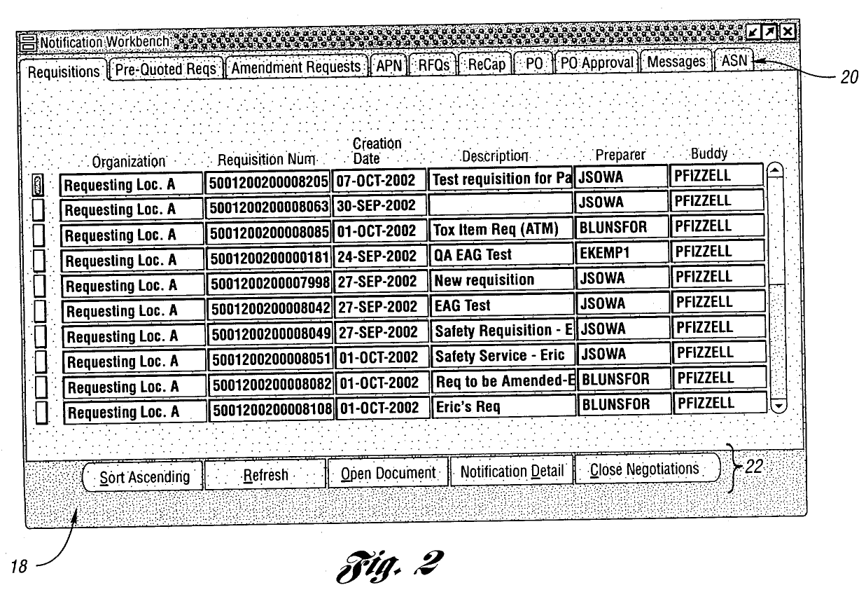

FIG. 2 is an example of a form for displaying buyer workbench information in accordance with an embodiment of the present invention. Form 18 can include several tabs for displaying notifications related to the subject of the tab. Tabs 20 can include, but are not limited to, requisitions, pre-quoted requisitions, amendment requests, APN, RFQs, ReCap, PO, PO Approval, Messages, and ASN. A requisitioner can select a tab to see notifications related to the subject of the tab.

The requisitions tab can list documents originating from requisitions. These documents can include, but are not limited to, new requisitions, reassigned requisitions, blanket releases that exceed the maximum release value.

The pre-quoted requisitions tab can list requisitions that have already been issued through the RFQ process, and have been returned to the requisitioner and re-approved. These requisitions, include, but are not limited to, APNs and requisitions returned for re-approval.

The amendment requests tab can list PO amendment requests initiated by a requisitioner.

The APN tab can list APN requisitions. These requisitions can disappear when a requisitioner returns the requisition, or the requisition is reassigned to another buyer.

The RFQs tab can list RFQs that are submitted (incomplete or active). If active, the RFQ can remain until either the RFQ due date is met or all of the suppliers have responded, whichever occurs first.

The ReCap tab can list active RFQs for which all quotes have been received or the RFQ due date has passed, whichever occurs first. In certain embodiments, in-process RFQs will display here if they have no due date.

The PO tab can list purchase orders that do not have a status of approved.

The PO approval tab can list POs requiring review approvals for purchasing managers and purchasing controllers.

The messages tab can list notifications that provide information only.

The ASN tab can list notifications to receiving buyers that an ASN has been sent by the supplier. In certain embodiments, ASNs are routed to a buyer only if the purchase order was generated without a requisition.

Form 18 can include one or more buttons 22 to manage the information displayed on form 18. The one or more buttons 22 can include, but are not limited to, sort (ascending or descending), refresh, open document, notification detail, and close notifications.

The sort (ascending or descending) button can be clicked on to sort the table appearing under the active tab by the column in which the cursor has been placed. This button can change depending on how the column is sorted at the time.

The refresh tab can be clicked on to refresh the contents of form 18.

The open document button can be clicked on to open the document related to the item appearing on the active table so that the buyer can work on it.

The notification detail button can be clicked on to open a notification detail form for more information about a notification. If there is no further detail, the button is not activated. In certain embodiments, this button is only active for PO approvals, messages, and ASN tabs.

The close notifications button can be clicked on to remove any marked notifications from the workbench. To mark a notification for closure, a user clicks on a check box appearing in front of the notification. To mark all notifications on a tab, the user chicks on a close check box. To delete most of the notifications, the user can click on the close check box and then select individual notifications to clear the checkmark before clicking. In certain embodiments, this button is only active for PO approvals, messages, and ASN tabs.

Buddy Workgroup Tool Functionality

The buddy workgroup tool includes an ability for users to share work with others within their workgroup area. The workgroup tool has the ability to grant access to work list notifications and document anytime there is an excessive workload or as a backup for vacations or leaves (scheduled and unscheduled). For example, an excessive workload can be assigned to two buyers who act as permanent buddy buyers in order to handle the workload.

The buddy workgroup tool includes an ability for buyers and approvers to enter another “buddy” users workbench/work list on an as needed basis due to regular processing, emergency or absence from office.

The buddy workgroup tool includes an ability for the original buyer and approver to have a Profile area to designate multiple “buddy” users.

The buddy workgroup tool includes an ability for the system administrator to give access to another user at the same level to enter the original user's work list.

The buddy workgroup tool includes an ability to separate work list and workbench needs.

The buddy workgroup tool includes an ability to create a document that reflect the original users ID and the “buddy” who processed it. For auditing and turnover tracking purposes the original dollars must remain with the original user.

A buddy buyer form can contain a list of values to select the appropriate buddy and a toggle switch to turn on/off the buddy's access to the original user's documents.

The original user can select an appropriate “buddy” from a list of values. In certain embodiments, a buddy can have an authority level different than the original user. For example, if a buyer is a buddy with a specialist (original user) then this relationship should also be in the List of Values. In this case, a verification that the buyer is in the same work group (department) as the specialist is necessary. When a buyer works on a document as the buddy, the buyer's approval chain can take over when submitted for approval.

Once a buddy has been assigned, the buyer's workbench shows the original and buddy buyer's work list together. This work list can be segregated from their own personal work list. For example, Buyer A can designate Buyer C as their Buddy, Buyer C can see their own work list along with Buyer A's work list that has a label stating that work list belongs to Buyer A.

The buddy buyer information can be stored in a new table. This table can include the name of the original user and the buddy assigned by the original user with the on/off toggle switch.

Once a user designates a buddy, the buddy can work on any of the documents that are in the original user's work list. The original user can retain ownership of the document but the buddy has maintenance capabilities to any of the documents until the original user removes the buddy from their buddy list.

The buddy workgroup tool functionality can be implemented using an Oracle procurement application. It should be understood that other procurement applications can be enhanced with the buddy workgroup tool functionality.

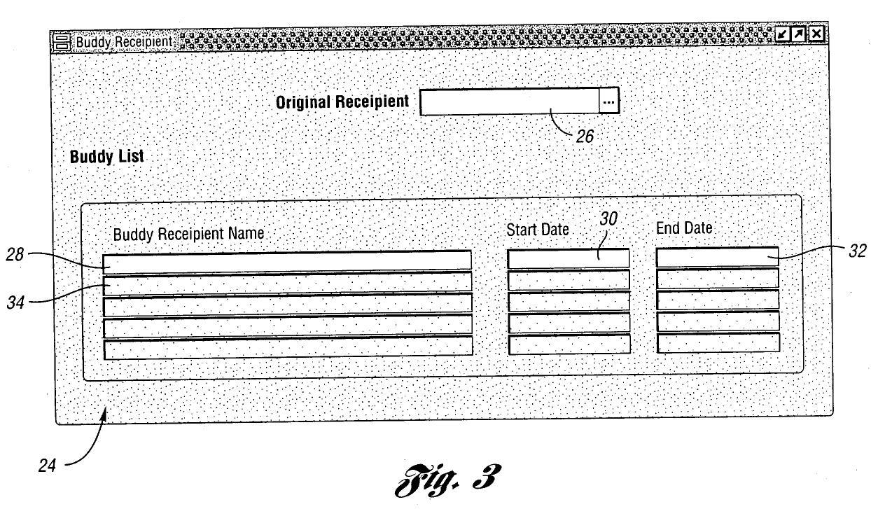

FIG. 3 is an example of a form for displaying buddy workgroup information in accordance with an embodiment of the present invention.

Form 24 can include original recipient input box 26 for entering a buyer's buyer code or a buyer code of a buyer assigning workload to another buyer. In certain embodiments, if a buyer is sending workload to another buyer, the buyer should enter their name in input box 26. To take over the work load of another buyer, that buyer's name is entered into input box 26.

Form 24 can include one or more buddy recipient name input boxes 28 for entering a buyer code of the buyer to whom the workload is to be shared. In certain embodiments, if a buyer is sending workload to another buyer, the other buyer's name is entered in input box 28. A buyer taking over another buyer's workload enters their name in input box 28.

Form 24 can include one or more start date input boxes 30 for entering the first day the selected buyer will start handling the assigning buyer's workload. In certain embodiments, the date is entered using the DD-MMM-YYYY format.

Form 24 can include one or more end date input boxes 32 for entering the last day the selected buyer will be handling the assigning buyer's workload. In certain embodiments, the date is entered using the DD-MMM-YYYY format. In yet other embodiments, the reassignment of workload ends at midnight on the end date. The buyer can leave input box 32 empty if it preferred to leave the end date open.

To enter additional buddy buyers in form 24, a user can click on next blank buddy recipient name field 34 and follow the above instructions.

To remove a buyer from the buddy list, click on the buddy recipient name field of the buddy buyer for removal and click a delete icon which can be displayed on a toolbar.

Requisitioners Workbench Tool Functionality

The requisitioners workbench tool provides users with a simple and organized way to review their current workload and process notifications and documents in a timely manner.

The requisitioners workbench tool allows requisitioners, approvers and controllers to access their daily workload of notifications and notification details, launch requisition documents and close notifications from a single screen and menu path. The user can view directly access a list of defined category items requiring action.

The requisitioners workbench tool includes the ability to provide a complete list of all Action Item Headers (categories) and the quantity of items requiring action within each header category in a requisitioner portal form.

The requisitioners workbench tool includes the ability to display requisitioners notifications and documents across operating units and/or legal entities.

The requisitioners workbench tool includes the ability to automatically switch responsibilities for launching documents and detailed notifications across responsibilities. It should be understood that a document refers to an electronic document used in the buying process, for example, requisitions, purchase orders, etc.

The requisitioners workbench tool includes the ability to categorize Requisitioner notifications and documents into meaningful folder names.

The requisitioners workbench tool includes the ability to categorize FYI notifications in a separate Folder.

The requisitioners workbench tool includes the ability to categorize all other miscellaneous notifications in a miscellaneous folder.

The requisitioners workbench tool includes the ability to launch notification detail from a work list.

The requisitioners workbench tool includes the ability to launch documents from notifications.

The requisitioners workbench tool includes the ability to sort notifications and documents in each work list folder.

The requisitioners workbench tool includes the ability to close notifications and documents.

Since requisitioners can have access to several responsibilities covering multiple operating units and notifications are triggered due to actions in any of the operating units, the requisitioners workbench can be accessible in all responsibilities and can consolidate notifications for all operating units. The requisitioner does not have to switch responsibilities to access their notifications and documents. The requisitioner can click an action item category tab within the work list. The action items can be displayed, showing each item requiring action by the user. After selecting an item for action, the users can be directed to the proper form and query the appropriate record using the data within the notification. When the action is completed and saved, the user can automatically return to the action item list. The item completed can be noted or deleted on the action item lists.

The requisitioners workbench can automatically switch the responsibility of a requisitioner, based on the operating unit (org_id) from which the notification was generated. The responsibility switch can be transparent to the Requisitioner.

The notifications can be grouped into each tab depending on the subject, what triggered the notification, specific message body of the notification, and the recipient for each notification. Table 1 lists a non-limiting example of categorizing requisition notification into subject header tabs.

TABLE 1

| Subject Header | What transaction | |
|---|---|---|
| Tab | action triggered the | Text of notification |
| Recipient (s) | notification | message |
| Approver | Someone in the | Purchase Requisition |
| Rejected | Approval chain has | # (nnnnn) has been |
| requisitioner | rejected the | rejected by approver |
| and approver | Requisition and it | (name of approver) |
| | sent back to the | |
| | originator | |
| Incomplete | Requisitions still | Purchase |
| requisitions | being routed in the | Requisitions # |
| requisitioner | approved process | (nnnnn) has been |
| and approver | | forwarded to your |
| | | approver (name of |
| | | approver) for |
| | | approval |
| Open PO's | Once the requisition | Standard Purchase |
| requisitioner | has a PO number | Order #nnnn, line # |
| | associated with it - | nnnn for supplier |
| | this tab should | (supplier name was |
| | contain all Req. to | created from |
| | PO data - This | requisition # |
| | could be PO's that | (nnnnn) |
| | have not been | |
| | approved by the | |
| | Buyer yet | |
| ASN's | Once an ASN is | ASN for Purchase |
| requisitioner | created by the | Order # (nnnn) line |
| | Supplier | # (nnnn) has been |
| | | submitted by |
| | | supplier |
| Others | When a requisition | Example the |
| requisitioner | line that was on a | Requestor has asked |
| | PO has been | for the return of |
| | cancelled - the | purchase order #, |
| | cancel information | line # |
| | should be returned | |
| | to the original | |
| | requestor | |
| FYI | Notifications that | Standard PO # (nnnn) |
| notification- | do not require | line # (nnnn) for |
| Approval chain | actions | supplier (supplier |
| requisitioner | | name) was created |
| | | from requisition # |
| | | (nnnn) |
| FYI | Notifications that | Supplier (xxxx) has |
| notification- | do not require | acknowledged receipt |
| Supplier PO | actions | fo Purchase Order # |
| acknowledgment | | (nnnn) |
| requisitioner | | |
| FYI | Notifications that | Purchase Requisition |
| notification- | do not require | # (nnnn) is now |
| Purchasing | actions | available |
| status | | |
| requisitioner | | |
| Approvals | When a requisition | Purchase Requisition |
| approver and | is in the approver's | # (nnnn) has been |
| controller | queue ready for | submitted for you |
| | approval | for approval |
| Approvals | A requisition has | Purchase Requisition |
| approver and | forwarded to the | # (nnnn) has been |
| controller | specific approver - | forwarded to you for |
| | outside of the | approval |
| | normal approval | |
| | chain | |
| Approvals | When a requisition | Purchase Requisition |
| approver and | is reassigned to | # (nnnn) has been |
| controller | another approver by | reassigned to you |
| | another approver or | for approval |
| | Controller not in | |
| | the normal approval | |
| | hierarchy | |

Notifications, which are informational and do not require action by the Requisitioner can be grouped under the FYI category.

A requisitioner can close notifications using the requisitioners workbench tool. The closed notifications should not be visible from the requisitioners workbench.

It should be understood that notifications can refer to messages generated by Oracle workflow. These messages could be triggered by an action or as event (for example, Data update by a certain user) or triggered by a time based concurrent program (for example, Daily summary of all incomplete Purchase Orders in the system). A notification can be comprised of a header and a body.

The requisitioner workbench tool functionality can be implemented using an Oracle procurement application. It should be understood that other procurement applications can be enhanced with the requisitioner workbench tool functionality.

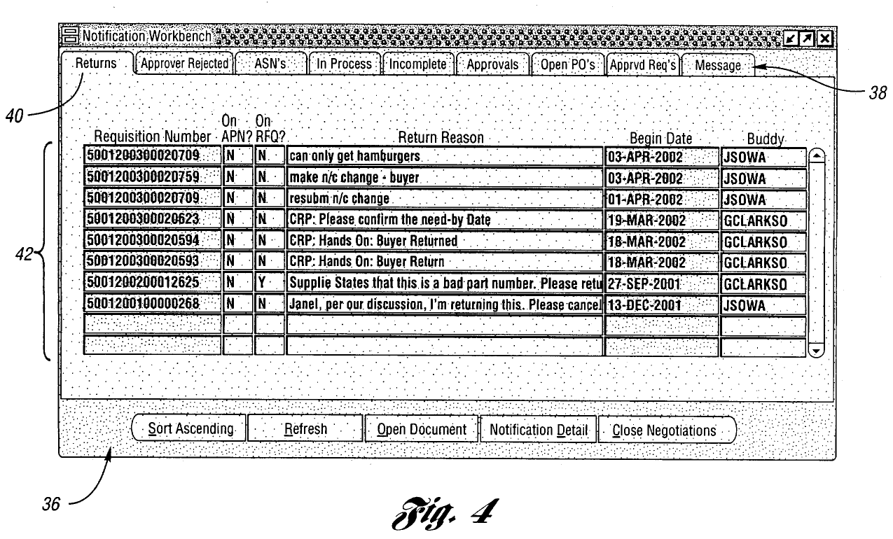

FIG. 4 is an example of a form for displaying requisitioner workbench information in accordance with an embodiment of the present invention.

Form 36 can include several tabs 38 for displaying organized lists of a requisitioner's notifications. One of tabs 38 can be returns tab 40 for listing requisitions returned by a buyer. These requisitions can include, but are not limited to, advanced purchase notifications (APNs) being returned with pricing information, and requisitions being returned for corrections.

Return tab 40 can include, but is not limited to, one or more fields 42, for example, requisition number, “On APN?”, “On RFQ?”, return reason, begin date, and buddy. The requisition number contains the requisition number of a returned requisition. The “On APN?” field indicates whether or not the requisition is on an APN. The “On RFQ?” field indicates whether or not the requisition is on a RFQ. The return reason field contains the reason a requisition was returned. Notably, this field often contains information that is helpful for resubmitting the requisition. The begin date displays the date a requisition was executed. The buddy field contains the name of the original owner of the notification.

Other tabs 38 can include, but are not limited to, approver rejected, ASNs, in process, incomplete, approvals, open POs, approved reqs, and message. The approver rejected tab can list requisitions rejected by approver, controller, Tox approver, PCPAS or safety approver. The ASNs tab can list all advance shipment notices sent by a supplier. The in process tab can list requisitions that have been forwarded for approval and the name of the approver. The incomplete tab can list requisitions in incomplete status. These can include, but are not limited to, requisitions that are re-routed from a requester. The open POs can list purchase orders that have been approved and are open for receiving. The approved requisitions tab can list requisitions that have been all the way through the approval chain and have been approved. The message tab can list system-generated notifications.

The following fields can be included on the approver rejected tab: requisitioner number, rejected reason, begin date, rejected by, and buddy. The requisitioner number field contains the requisition number of a rejected requisition. The rejected reason field contains the reason a requisition was returned. Notably, this field often contains information that is helpful for resubmitting the requisition. The begin date displays the date a requisition was executed. The rejected by field contains the name of the approver who rejected the requisition. The buddy field contains the name of the original owner of the notification.

The following fields can be included on the ASN's tab: close check box, organization, status, subject, begin date, due date, and buddy. The close check box is clicked on to mark a requisition to be closed. The organization field contains the organization of the requisitioner. The status field contains a label for the requisition. The subject field contains a message for the notification and a document number associated with it. The begin date contains the date the requisition was executed. The due date field contains the date that an order is expected. The buddy field contains the name of the original owner of a notification.

The following fields can be included on the in process tab: close check box, organization, status, subject, begin date and buddy. The close check box is clicked on to mark a requisition to be closed. The organization field contains the organization of the requisitioner. The status field contains a label for the requisition. The subject field contains a message for the notification and a document number associated with it. The begin date contains the date the requisition was executed. The buddy field contains the name of the original owner of a notification.

The following fields can be included on the incomplete tab: requisitioner number, description, re-route, begin date, and buddy. The requisitioner number field contains the number of a returned requisition. The description field contains the description of the requisition. The re-route field indicates whether or not a requisition has been re-routed from a requestor. The begin date contains the date the requisition was executed. The buddy field contains the name of the original owner of a notification.

The following fields can be included on the approvals tab: close check box, organization, status, subject, begin date, due date, and buddy.

The following fields can be included on the open PO's tab: close check box, organization, status, subject, begin date, due date and buddy. The close check box is clicked on to mark a requisition to be closed. The organization field contains the organization of the requisitioner. The status field contains a label for the requisition. The subject field contains a message for the notification and a document number associated with it. The begin date contains the date the requisition was executed. The due date field contains the date that an order is expected. The buddy field contains the name of the original owner of a notification.

The following fields can be included on the approved reqs tab: close check box, organization, status, subject, begin date, due date and buddy. The close check box is clicked on to mark a requisition to be closed. The organization field contains the organization of the requisitioner. The status field contains a label for the requisition. The subject field contains a message for the notification and a document number associated with it. The begin date contains the date the requisition was executed. The due date field contains the date that an order is expected. The buddy field contains the name of the original owner of a notification.

The following fields can be included on the message tab: close check box, organization, status, subject, begin date, due date and buddy. The close check box is clicked on to mark a requisition to be closed. The organization field contains the organization of the requisitioner. The status field contains a label for the requisition. The subject field contains a message for the notification and a document number associated with it. The begin date contains the date the requisition was executed. The due date field contains the date that an order is expected. The buddy field contains the name of the original owner of a notification.

While the best mode for carrying out the invention has been described in detail, those familiar with the art to which this invention relates will recognize various alternative designs and embodiments for practicing the invention as defined by the following claims.

What is claimed:

1. A computer-implemented method for managing workload of procurement buyers, the method comprising:
receiving a requisition database, the requisition database including a plurality of requisition documents, each of the plurality of requisition documents including an organization and a requisition number, the plurality of requisition documents being assigned to at least two different operating units;
receiving buyer information of one or more buyers that are responsible for procuring products or services in at least two operating units based on at least one of the plurality of requisition documents;
automatically assigning at least one of the plurality of requisition documents to an assigned buyer selected from the one or more buyers based on the buyer information and the organization and the requisition number of the at least one requisition documents to obtain an at least one assigned requisition document; and
formatting information contained in the at least one assigned requisition document to obtain formatted requisition information for display to the assigned buyer.

2. The method of claim 1 wherein the one or more buyers are responsible for procuring products or services in at least two legal entities.

3. The method of claim 1 wherein the formatted requisition information is displayed to the assigned buyer in an electronic form.

4. The method of claim 3 wherein the electronic form includes one or more tabs.

5. The method of claim 4 wherein the one or more tabs include a requisitions tab.

6. The method of claim 4 wherein the one or more tabs include a requisitions tab, a pre-quoted requisition tab, and an amendment requests tab.

7. The method of claim 4 wherein the one or more tabs include at least five of the following tabs: a requisitions tab, a pre-quoted requisition tab, an amendment requests tab, and APN tab, an RFQs tab, a recap tab, a purchase order tab, a PO approvals tab, a messages tab and ASN tab.

8. The method of claim 1 further comprising assigning at least on of the one or more requisition documents from the assigned buyer to a buddy buyer.

9. A computer-implemented system for managing workload of procurement buyers, the system comprising at least one server computer for communicating with at least one client computer, the at least one server computer being configured to:
receive a requisition database, the requisition database including a plurality of requisition documents, each of the plurality of requisition documents including an organization and a requisition number, the plurality of requisition documents being assigned to at least two different operating units;
receive buyer information of one or more buyers that are responsible for procuring products or services in at least two operating units based on at least one of the plurality of requisition documents;
automatically assign at least one of the plurality of requisition documents to an assigned buyer selected from the one or more buyers based on the buyer information and the organization and the requisition number of the at least one requisition documents to obtain an at least one assigned requisition document; and
format information contained in the at least one assigned requisition document to obtain formatted requisition information for display to the assigned buyer.

10. The system of claim 10 wherein the one or more buyers are responsible for procuring products or services in at least two legal entities.

11. The system of claim 9 wherein the formatted requisition information is displayed to the assigned buyer in an electronic form.

12. The system of claim 12 wherein the electronic form includes one or more tabs.

13. The system of claim 13 wherein the one or more tabs include a requisitions tab.

14. The system of claim 13 wherein the one or more tabs include a requisitions tab, a pre-quoted requisition tab, and an amendment requests tab.

15. The system of claim 13 wherein the one or more tabs include at least five of the following tabs: a requisitions tab, a pre-quoted requisition tab, an amendment requests tab, and APN tab, an RFQs tab, a recap tab, a purchase order tab, a PO approvals tab, a messages tab and ASN tab.

16. The system of claim 10 wherein the at least one server computer is further configured to assign at least on of the one or more requisition documents from the assigned buyer to a buddy buyer.

17. A program for controlling a computer of a server for managing workload of procurement buyers, the program comprising:
instructions for receiving a requisition database, the requisition database including a plurality of requisition documents, each of the plurality of requisition documents including an organization and a requisition number, the plurality of requisition documents being assigned to at least two different operating units;
instructions for receiving buyer information of one or more buyers that are responsible for procuring products or services in at least two operating units based on at least one of the plurality of requisition documents;
instructions for automatically assigning at least one of the plurality of requisition documents to an assigned buyer selected from the one or more buyers based on the buyer information and the organization and the requisition number of the at least one requisition documents to obtain an at least one assigned requisition document; and
instructions for formatting information contained in the at least one assigned requisition document to obtain formatted requisition information for display to the assigned buyer.

18. A computer-implemented method for managing workload of procurement requisitioners, the method comprising:
receiving a requisition database, the requisition database including a plurality of requisition documents, each of the plurality of requisition documents including an organization, a requisition number and a requisitioner; and
formatting the information contained in at least one requisition document to obtain formatted requisition information for display to the requisitioner associated with the requisition document, the requisitioner associated with the requisition document being responsible for procurement in at least two operating units, the formatted requisition information relied upon for the procurement of products or services.

19. The method of claim 18 wherein the formatted requisition information is displayed to the requisitioner in an electronic form.

20. The method of claim 19 wherein the electronic form includes one or more tabs.

21. The method of claim 20 wherein the one or more tabs includes a returns tab.

22. The method of claim 20 wherein the one or more tabs include a returns tab, an approver rejected tab, and an ASNs tab.

23. The method of claim 20 wherein the one or more tabs include at least five of the following tabs: a returns tab, an approver rejected tab, an ASNs tab, an in process tab, an incomplete tab, an approvals tab, an open purchase orders tab, an approved reqs tab and a message tab.

24. A computer-implemented system for managing workload of procurement requisitioners, the system comprising at least one server computer for communicating with at least one client computer, the at least one server computer being configured to:
receive a requisition database, the requisition database including a plurality of requisition documents, each of the plurality of requisition documents including an organization, a requisition number and a requisitioner; and
format the information contained in at least one requisition document to obtain formatted requisition information for display to the requisitioner associated with the requisition document, the requisitioner associated with the requisition document being responsible for procurement in at least two operating units.
